(19) United States
(12) Patent Application Publication
(10) Pub. No.: US 2007/0245571 A1
(43) Pub. Date: Oct. 25, 2007

(54) REINFORCED MEDIA CUTTING DEVICE

(75) Inventor: Scott D. Pearson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/616,996

(22) Filed: Dec. 28, 2006

Related U.S. Application Data
(63) Continuation-in-part of application No. 11/408,781, filed on Apr. 21, 2006.

(51) Int. Cl. B26B 29/00

(52) U.S. Cl. 30/294

(57) ABSTRACT

An elongated device for cutting media is provided. The device has a centerline axis along its length dividing it into first and second halves. The device includes (a) a handle having front and rear ends; (b) a head extending from the front end of the handle; and (c) a blade disposed in the head and having a cutting edge where a leading edge of the cutting edge intersects the top surface of a guide at a first reference point. The device further includes a guide, where the exit of the guide is asymmetric.

### CROSS-REFERENCE TO RELATED APPLICATIONS

The present invention is a continuation-in-part of U.S. application Ser. No. 11/408,781, filed on Apr. 21, 2006, which is incorporated by reference in its entirety.

### FIELD OF INVENTION

The present invention relates to a media cutting device with a reinforced guide design. In particular, the guide of the device is designed so as to split the path of cut media, where one side of the cut media is directed to an exit path that differs in height from the other side.

### BACKGROUND

There are a variety of tools available today for cutting media such as paper, plastics, cardboard, and the like, the most common tools being scissors and utility knives. Some of the drawback of scissors and utility knives include exposed cutting edges and in some designs, there may be a pointed end that can inadvertently hurt someone if the scissor or utility knife is mishandled.

While scissors and utility knives are commonplace, those skilled in the art have designed new and useful cutting devices. For example, 3M Company sells a Scotch® Cutter for cutting numerous types of media, including, but not limited to, gift-wrapping paper.

There remains a need for new types of cutting devices.

### SUMMARY

The present invention provides a media cutting device with a reinforced guide where cut media leaves the device along first and second paths that are at different heights. It is believed that by splitting the path of the cut media at different exit heights reduces the cutting stresses that the device experiences and imparts to the media during cutting. The device is capable of cutting higher weight media (i.e., higher than 20 pound paper used in conventional photocopying machines), less flexible media, and media generally resistant to cutting. The present invention further provides a lightweight, hand held, portable cutting device.

In one aspect, the present invention pertains to an elongated device for cutting media, the device having a centerline axis along its length dividing it into first and second halves, the device comprising (a) a handle having front and rear ends; (b) a head extending from the front end of the handle, the head comprising (i) a cover having sidewalls extending therefrom and (ii) a guide disposed substantially underneath the cover and having opposing top and bottom surfaces, the top surface disposed proximate to the cover, the bottom surface being substantially planar, the guide further having first and second halves divided along the centerline axis, a first exit disposed on the first half of the guide and a second exit disposed on the second half of the guide; and (c) a blade disposed in the head and having a cutting edge where a leading edge of the cutting edge intersects the top surface of the guide at a first reference point, wherein a first line connecting the first reference point to the first exit on the first half of the guide is not parallel with the bottom surface of the guide.

As used herein, the “head” is that portion of the device where the blade is housed and includes the cover and the guide; the “cover” is that portion of the head that surrounds the cutting edge of the blade, the cover functioning in part to isolate a user from the blade's cutting edge; and the “guide” is that portion of the head that rides underneath the media during cutting, the guide intersecting a portion of the blade.

In this embodiment, the term “about” is presumed to modify all numerical dimensional values.

### BRIEF DESCRIPTION OF THE DRAWINGS

The invention can be better described with reference to the drawings, wherein:

FIG. 1 is an isometric view of an exemplary device of the present invention;

FIG. 2 is a right side view of the embodiment of FIG. 1;

FIG. 3 is a left side view of the embodiment of FIG. 1;

FIG. 4 is a bottom plan view of the embodiment of FIG. 1;

FIG. 5 is a front perspective view of the head of the embodiment of FIG. 1;

FIG. 6 is a front view of the head of the embodiment of FIG. 1;

FIG. 7 is rear perspective view of the head of the embodiment of FIG. 1; and

FIG. 8 is a side view of FIG. 3.

These figures are idealized, are not drawn to scale, and are intended merely for illustrative purposes.

### DETAILED DESCRIPTION

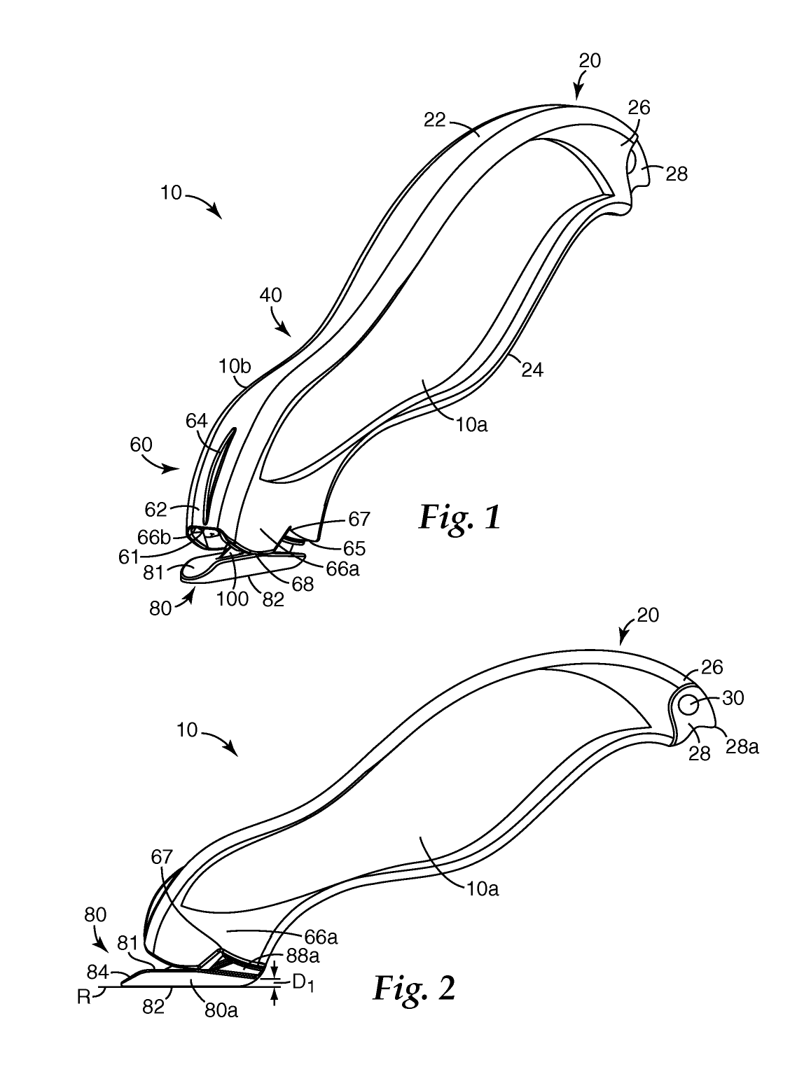

FIG. 1 shows an isometric view of an exemplary cutting device 10 of the present invention. The cutting device includes an elongated handle 20 having front and rear ends, the rear end generally denoted as area 26. In some embodiments, a puncture tool 28 is disposed at the rear end of the handle. As best shown in FIG. 4, the device has a centerline axis (C_{L}) along its length dividing it into a first half 10a and a second half 10b so that each of the handle, the cover, and the guide has a corresponding first half and a corresponding second half. The handle has a back or topside 22 and a belly or underside 24. In use, when a consumer holds the device in his hand, the palm would most likely be in contact with the back of the handle while the fingers wrap around the underside. The handle has curvature on both is back and underside to provide comfortable grip. The handle necks down towards its front end to a throat 40. Extending from the throat, i.e., the front end of the handle is a head 60.

While the device of FIG. 1 is shown to include an elongated handle for grasping by the user's hand, it is within the scope of the present invention to use other handle designs. For example, the handle could be oval or rectangular shaped and substantially flat so that it can be grasped in the area between the user's thumb and forefinger. Alternatively, the handle can be in the form of a “T” shaped bar also for grasping between the forefinger and the middle finger or between any other two fingers.

The head includes a cover 62 having two sidewalls extending therefrom, a first sidewall indicated generally as 66a and a second sidewall, 66b. However, a device with a single sidewall is within the scope of this invention. In one embodiment, each of the sidewall includes media contact point 68. If desired, the sidewall can have more than one media contact point. In one embodiment, an outer surface of at least one sidewall is substantially straight allowing the device to be used against a straight edge, such as a ruler. The outer surface of the cover sidewall is that surface that is readily accessible to the user. The cover has a forward end, generally denoted as 61. During cutting, the cover forward end is that end that first encounters uncut media. On the first half 10a of the head, notch 67 lies proximate an exit 65 of the head. Optionally, the cover includes reference mark 64 to help the user align the device with the media, which is especially useful if the media contains reference lines for the user to follow during cutting. While the reference mark in this embodiment lies along the centerline axis on the cover, it can be located on elsewhere, such as on the guide, on the handle, or off the centerline axis. Furthermore, the reference mark may be in form of light indicating means, such as a light emitting diode that projects a beam of light onto the media.

The device further includes a guide 80 disposed substantially underneath the cover and between the two sidewalls. By “substantially” it means a major portion, i.e. greater than 50%, of the guide is disposed under the cover. The guide has opposing top surface 81, which is proximate to an inside surface of the cover (see reference number 63 of FIG. 4), and a substantially planar bottom surface 82. A blade 100 intersects at least the top surface of the guide. The device is designed such that the sidewalls shroud at least a portion of the blade, thereby making the blade inaccessible to the user. The bottom surface of the guide, being substantially planar, allows it to glide over a cutting surface where the media rests. The bottom surface of the guide also serves as a reference plane (sometimes shown as a line “R”) from which other points of the guide will be referenced. In use, uncut media enters the device at the forward end of the cover and the forward end of the guide and cut media leaves the device at the exit of the head and the exit of the guide.

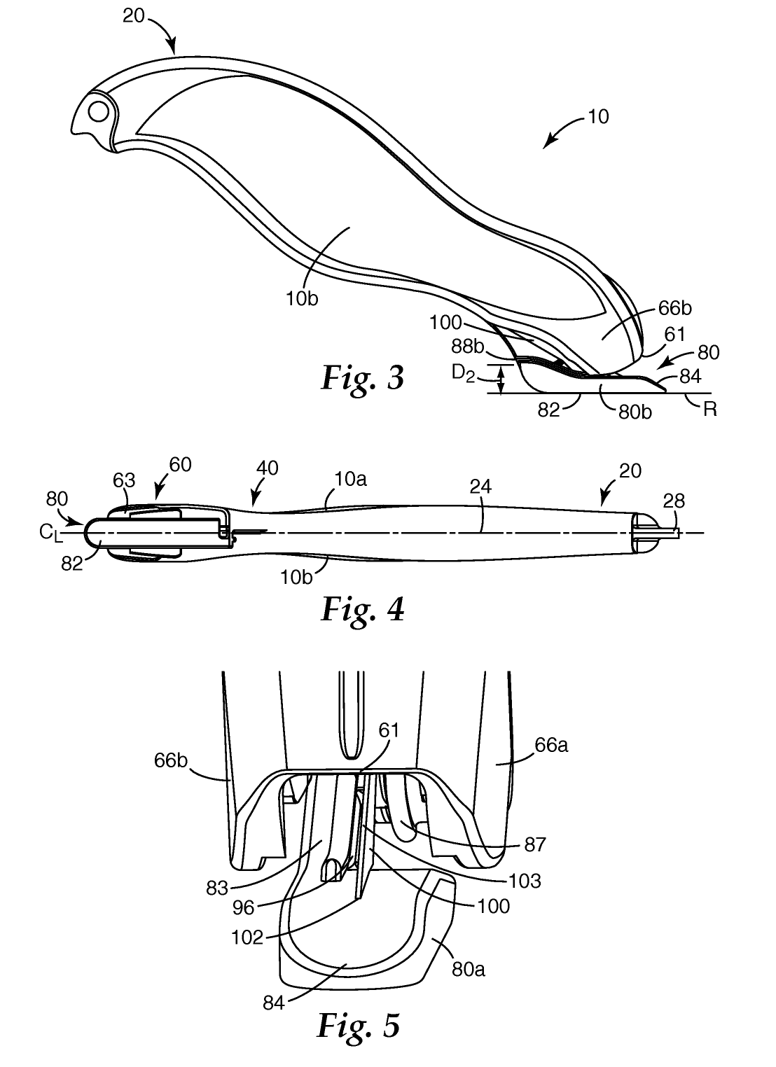

FIGS. 2 and 3 show first half 10a (right) side and second half 10b (left) side views of the embodiment of FIG. 1, respectively. The guide has a forward end 84 and an exit, and due to the asymmetry at the exit, a first exit 88a differs from a second exit 88b. The first and second exits are can be substantially straight or can have an upward or downward draft moving towards the centerline of the device. The forward end of the guide extends beyond the forward end of the cover so that at least this portion of the guide is not disposed underneath the cover. An imaginary line can be drawn orthogonal to the bottom surface at the exit of the guide. A first distance (denoted as D₁ in FIG. 2) from the guide first exit 88a to the guide bottom surface is less than a second distance (denoted as D₂ in FIG. 3) from the guide second exit 88b to the guide bottom surface. With reference to FIG. 7, the first guide exit 88a from which the distance D₁ is measured, spans from a guide first sidewall 80a to a first internal wall 94. Similarly, the guide second exit 88b from which D₂ is measured spans from a guide second sidewall 80b to a second internal wall 96.

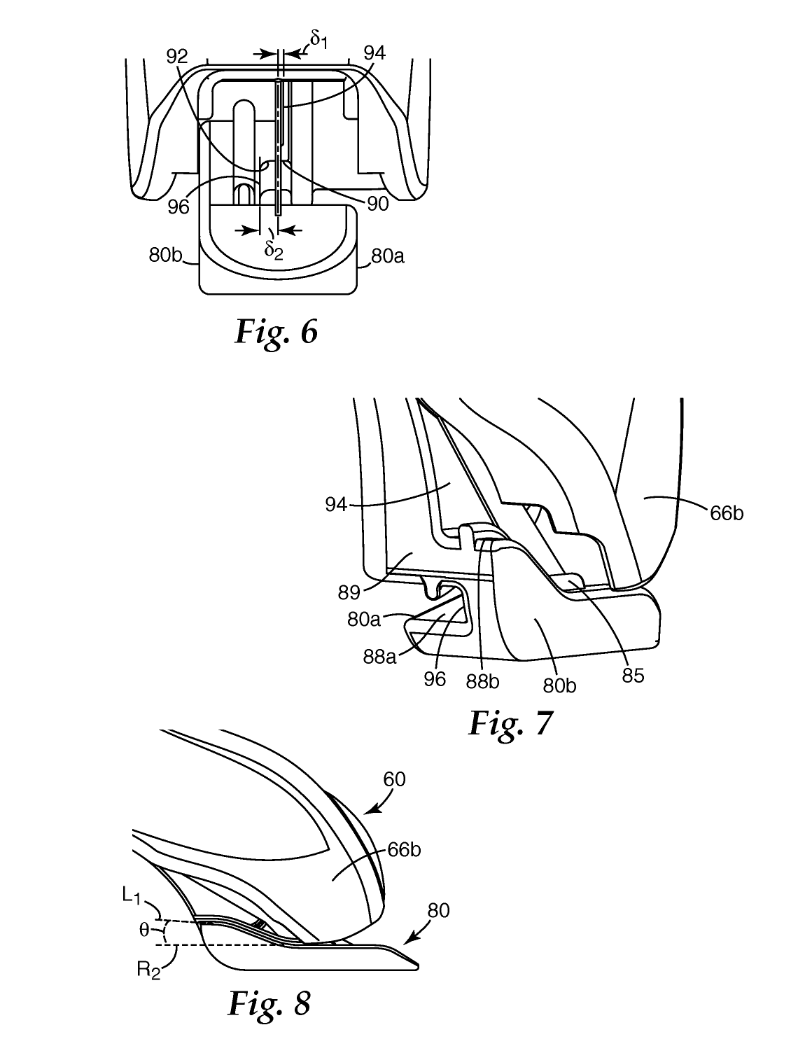

Optionally, the handle can include aperture 30 to aid in the transportation, display, or storage of the device. For example, a lanyard can be threaded through the aperture. In one embodiment, an outer surface of at least one of the guide's first and second sidewalls is substantially straight, allowing the device to be used against a straight edge. The outer surface of the guide sidewall is generally that surface that is readily accessible to the user. A portion of the blade intersects the guide between the forward and exits; the intersection point occurs at a leading edge of the blade (see ref. no. 102 in FIG. 5)(also referred to herein as a “first reference point”). FIG. 5 shows in detail a leading edge 102. A first imaginary line connecting the first reference point to the first exit 88a on the first half of the guide is not parallel with the bottom surface of the guide. Similarly, a second imaginary line connecting the first reference point to the second exit 88b on the second half of the guide is not parallel with the bottom surface of the guide. With reference to the bottom surface 82, the forward end of the guide has a generally upward slope as viewed from its tip towards the leading edge of the blade. The forward end of the guide is generally symmetrical as viewed from the centerline axis. The asymmetry in the guide is further described below with reference to FIGS. 5 and 6.

To exemplify illustrative dimensions of the device as examples and not as limitations, the device of FIG. 1 has a general length, measured along the centerline axis from the forward end 84 of the guide to a tip 28a of the puncture tool, of 6.5 inch (16.5 cm), a width of the handle, measured at its widest point and perpendicular to the centerline axis, of 0.625 inch (15.9 mm), a width near the throat section, measured perpendicular to the centerline axis, of 0.375 inch (9.5 mm), and a width of the head, measured perpendicular to the centerline axis near the exit of the guide, of 0.5 inch (12.7 mm). The length of the guide, as measured from the forward end to about the exit on the bottom surface, is about 1.4 inch (3.6 cm) and a width of about 0.31 inch (0.79 cm). The distance from the leading edge of the blade to the exit of the guide is less than 2 inch (5 cm).

FIG. 4 shows a bottom plan view of the device of FIG. 1 with the centerline axis down its length. From this bottom plan view, one can see that the guide is asymmetric at its exit. Furthermore, an inside surface of the cover has been indicated as reference number 63, which surface is proximate to the top surface of the guide and which surrounds the cutting edge of the blade.

Turning now to a more detailed view of the guide, FIG. 5 shows a front view of the head with the forward end 61 of the cover and the forward end 84 of the guide directly in sight. The leading edge 102 of the blade 100 intersects the top surface of the guide. In one embodiment, the portion of the blade closest to the leading edge is embedded in the guide. The trailing edge of the blade is disposed on at least the inside surface of the cover (not shown). In one embodiment, the portion of the blade closest to the trailing edge is embedded in the cover and the head. The cutting edge of the blade is referenced as 103. The media, once cut, will travel in two different paths. A first path directs the cut media in a generally downward direction because, with respect to the reference plane, the top surface of the first half of the guide (i.e., the half associated with guide sidewall 80a) includes a downward slope from the leading edge of the blade to the guide first exit. A second path directs the cut media in a generally upward direction because, with respect to the reference plane, the top surface of the second half of the guide (i.e., the half associated with guide sidewall 80b) includes an upward slope from about the leading edge of the blade to the second exit.

Certain features are also used in the inventive device to ensure that the cut media leaves the device smoothly. For example, on the inside surface of the first half of the cover and moving to the exit of the head, and adjacent to the blade, lay a first rail 87. With reference to FIG. 6, among other aspects, the first rail functions to minimize, if not eliminate, the possibility of the cut media from being caught in a first internal corner 90. On the second half of the guide, from about past the leading edge of the blade to the second guide exit 88b lays a second rail 85. Among other aspects, the second rail functions to minimize, if not eliminate, the possibility of the cut media from being caught in a second internal corner 92. While rails are shown, it is within the scope of the invention to use any first or second deflectors to direct the cut media away from the first and second internal corners.

FIG. 6 further shows several internal dimensions of the inventive device. A first distance from a blade longitudinal centerline (i.e., a center line running along the length of the blade) to a first guide internal wall 94 is denoted as δ₁. A second distance from the blade centerline to a second guide internal wall 96 is denoted as δ₂. These internal walls lie nearly immediately adjacent to the blade and lie substantially parallel to the blade's longitudinal axis. In one embodiment, δ₁ is less than or equal to δ₂. Furthermore, the first and second internal walls are located on the first and second halves of the device as shown in the figure, i.e., the first internal wall lies on the first half of the guide and the second internal wall lies on the second half of the guide. These design features along with the rails or protrusions further allow a user to cut media using a relatively small radius of curvature, e.g., about a 1 inch (2.54 cm) radius, when needed. The design features also minimize the possibility that incoming uncut media diverge too much at the leading edge of the blade thereby causing the media to tear. Finally, the design features also minimize the possibility that cut media will fold upon itself when exiting the device.

In another embodiment, the values for δ₁ and δ₂ are substantially zero, i.e., the first and second internal walls are nearly aligned with the blade centerline. FIG. 6 shows δ₁ and δ₂ to be positive values, i.e., numerical values greater than zero. Thus, the first internal wall 94 lays to the right of the blade centerline while second internal wall 96 lays to the left of the blade centerline. The more positive the values for δ₁ and δ₂, the larger is the gap between the blade centerline and the first and second internal wall, and in general, the more readily the device will facilitate cutting curves or curves having a smaller radius of curvature. Furthermore, at least one of δ₁ and δ₂ and can take on a negative value. This design would translate to a first internal wall being disposed to the left of the blade centerline while the second internal wall 96 being disposed to the right of the blade centerline, as viewed in FIG. 6.

FIG. 7 shows a rear perspective view of the exit of head and the exit of the guide directly in sight. Extending from the head of the device is a crossbeam 89 from which the guide protrudes. In one aspect, the crossbeam connects the first half of the guide to the second half at its exit. The crossbeam reinforces the guide and the entire device thereby allowing it to handle media more sturdy than paper, such as wallpaper and the like.

FIG. 8 shows a side view of the second half of the guide. An angle theta represents the angle between two lines L₁ and R₂. The line L₁ connects the guide second exit, 88b, and the first reference point. The line R₂ is the a line that lies in the plane of the bottom surface of the guide translated up to the first reference point. In one embodiment, the angle theta is greater than 5°. In another embodiment, the angle theta is less than about 20°.

Now turning to the various parts of the device, in one embodiment, the head, handle, and guide are integrally formed. It is within the scope of the invention, however, for the various parts to be formed separately and thereafter joined together by any suitable means. For example, the first half of the device can be formed separately from the second half of the device and a blade is added before the assembly of the two halves. Whether or not integrally formed, the device can be made from a variety of materials, including metal, wood, polymer, ceramics, and combinations thereof. Injection molded polymers are also useful. Suitable injection molded polymers include, but are not limited to, polyolefins (such as, but not limited to, polypropylene, polystyrene, high impact polystyrene) and acrylonitrile-butadiene-styrene copolymer. The handle itself can be made from a combination of polymers as well. For example, the handle can be made of a first polymer and a second polymer, typically a softer polymer (as reflected in the durometer value) than the first polymer, can be over molded on the first polymer to provide a soft touch effect. If desired, different colors can be used for the first and second polymers to provide additional aesthetic appeal to the customer.

While the figures above reference the blade as a tool to cut the media, other means for cutting the media can be used. For example, a wire can be used in place of the blade. While the cutting edge of the blade is shown to be substantially a straight, linear edge extending from the leading edge to the trailing edge, other designs can be used. For example, the cutting edge may be beveled, chiseled, serrated, corrugated, scalloped, or curved. The blade or any means for cutting the media can be of any number of geometries, such as, but not limited to, triangular, rectangular, or circular. The circular geometry can be advantageous in that if the cutting edge becomes dull, the blade can be rotated so that a new section of the circular blade will be exposed for cutting. If desired, an advancing mechanism can be added to the device to allow for rotation of the cutting edge. The blade or means for cutting the media can be made from a wide variety of materials, including metals, ceramics, and plastics. Suitable metals include, but are not limited to, stainless steel, cold rolled steel, cold roll nickel plated steel, copper, and brass. Furthermore, the blade can be designed so as to be replaceable, allowing the user to replace worn blades with new ones, as described in copending U.S. application Ser. No. 11/408,781.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. An elongated device for cutting media, the device having a centerline axis along its length dividing it into first and second halves, the device comprising:
a handle having front and rear ends;
a head extending from the front end of the handle, the head comprising (i) a cover having a sidewall extending therefrom and (ii) a guide disposed substantially underneath the cover and having opposing top and bottom surfaces, the top surface being proximate to the cover, the bottom surface being substantially planar, the guide further having first and second halves divided along the centerline axis, a first exit disposed on the first half of the guide and a second exit disposed on the second half of the guide; and
a blade disposed in the head and having a cutting edge where a leading edge of the cutting edge intersects the top surface of the guide at a first reference point,
wherein a first line connecting the first reference point to the first exit on the first half of the guide is not parallel with the bottom surface of the guide.

2. The device of claim 1, wherein a second line connecting the first reference point to the second exit on the second half of the guide is not parallel with the bottom surface of the guide.

3. The device of claim 1, wherein at least one of the sidewalls of the cover includes an outer surface that is substantially straight.

4. The device of claim 1, wherein the guide further includes two sidewalls, one on each half of the guide and at least one of the sidewalls of the guide includes an outer surface that is substantially straight.

5. The device of claim 1, wherein the distance from the first reference point to the guide first or second exit is less than about two inches.

6. The device of claim 1 further comprising a first deflector disposed on an inside surface of the first half of the cover and adjacent to the blade.

7. The device of claim 6, wherein the first deflector is in the form of a first rail that begins on the inside surface of the first half of the cover adjacent to the blade and extends to the exit of the head.

8. The device of claim 1 further comprising a second deflector disposed in the second half of the guide proximate to and past the leading edge of the blade and away from a forward end of the guide.

9. The device of claim 8, wherein the second deflector is in the form of a second rail begins proximate to the blade past its leading edge and extends to the second exit of the guide.

10. The device of claim 1, wherein the first half of the guide, the top surface of the guide has a downward slope starting from about the leading edge of the blade to the guide first exit, the downward slope being referenced with respect to the bottom surface of the guide.

11. The device of claim 1, wherein in the second half of the guide, the top surface of the guide has a upward slope starting from about the leading edge of the blade to the guide second exit, the upward slope being referenced with respect to the bottom surface of the guide.

12. The device of claim 11, wherein an angle theta is formed by an intersection of two lines, L₁ and R₂, wherein the line L₁ connects the guide second exit to the first reference point, the line R₂ is a line that lies in the plane of the bottom surface of the guide, the line being translated to the first reference point, and the angle theta is greater than about 5° and less than about 20°.

13. The device of claim 1 further comprising a puncture tool disposed at the rear end of the handle.

14. The device of claim 1 formed from an injection-molded polymer.

15. The device of claim 14, wherein the injection molded polymer is selected from the group consisting of polyolefins and acrylonitrile-butadiene-styrene copolymer.

16. The device of claim 14, wherein the handle is formed of two different polymers wherein a first polymer has a different property from a second polymer, the property selected from a group consisting of durometer, color, and combinations thereof.

17. The device of claim 1, wherein a first diameter D₁, measured from the guide first exit normal to the guide bottom surface, is less than a second distance D₂, measured from the guide second exit normal to the guide bottom surface.

18. The device of claim 1, wherein a first distance, δ₁ is measured from a blade longitudinal centerline to a first internal wall of the guide and a second distance, δ₂, is measured from the blade longitudinal centerline to a second internal wall of the guide and wherein δ₁ and δ₂ can take on the following permutations: δ₁ is less than δ₂, δ₁ is equal to δ₂, and δ₁ and δ₂ are substantially zero.

19. The device of claim 1, wherein a portion of the blade is embedded in at least one of the guide and the cover.

20. The device of claim 1, wherein the blade is replaceable.
